(19) United States
(12) Patent Application Publication
(10) Pub. No.: US 2008/0119069 A1
(43) Pub. Date: May 22, 2008

(54) Board device and board

(75) Inventor: Iwane Ichiyama, Nomi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA MATSUSHITA DISPLAY TECHNOLOGY CO., LTD.

(21) Appl. No.: 11/812,833

(22) Filed: Jun. 22, 2007

(30) Foreign Application Priority Data
Nov. 21, 2006 (JP) 2006-314082

(51) Int. Cl. H01R 12/08

(52) U.S. Cl. 439/77

(57) ABSTRACT

In a state before TCPs are bonded under thermocompression, the pitch between a board side terminal group located at the outermost end and an adjacent board side group thereto is set to be smaller than predetermined pitches under the TCPs are bonded under thermocompression, thereby suppressed is the positional displacement between each second tape side terminal group and each board side terminal group due to extension of board main bodies of the PCBs when TCPs are bonded under thermocompression.

### INCORPORATION BY REFERENCE

The present application claims priority under 35 U.S.C. § 119 to Japanese Patent Application No. 2006-314082 filed on Nov. 21, 2006. The content of the application is incorporated herein by reference in its entirety.

### FIELD OF THE INVENTION

The present invention relates to a board device to which a board having a terminal group of a plurality of terminals arranged in juxtaposition with one another is bonded under thermocompression, and the board.

### BACKGROUND OF THE INVENTION

For example, in a liquid crystal display device or the like as a display device, pixels are formed on a liquid crystal panel as a display element in a matrix form, and by TAB (Tape Automated Bonding) mounting, thin film transistors (TFTS) as switching elements for driving these pixels are electrically and mechanically connected to a board having various kinds of circuits formed thereon via a flexible board such as COF (Chip On FPC) or TCP (Tape Carrier Package) having flexibility such as polyimide tape on which driver ICs for driving these thin film transistors are mounted.

The flexible board as described above is provided with a terminal group of a plurality of terminals arranged in juxtaposition with one another. On the board, a plurality of terminal groups each of which has a plurality of terminals corresponding to the terminal number of the terminal group of each flexible board are juxtaposed with one another at a predetermined pitch (TAB pitch), corresponding to the number of the flexible boards subjected to thermocompression. The flexible boards are automatically bonded to the board side at the TAB pitch under thermocompression by anisotropic conductive film, that is, ACF (Anisotropic Conductive Film), whereby the respective terminals of these terminal groups are electrically and mechanically connected to the board.

The flexible boards extend when the respective terminals thereof are connected to the board terminals by the thermocompression bonding. Therefore, as disclosed in Japanese Laid-Open Patent Publication No. 2002-341786, pitch correction is carried out on the terminals of the flexible boards in accordance with the extension amount concerned before the terminals of the flexible boards are connected to the board terminals, that is, so-called reducing correction is carried out, whereby the pitch of the terminals of each flexible board is set to be equal to the pitch of the terminals of the board when they are bonded to one another by thermocompression bonding.

However, in the above construction, when the thermocompression bonding is carried out on the flexible boards, the board side also extends in the longitudinal direction, and thus the pitch of the terminal groups of the board is varied in the longitudinal direction. Therefore, there is a risk that in particular the terminal group of the board which is located at the outermost end is positionally displaced with respect to the terminal group of the flexible board.

In addition, recently, corresponding to a large-scale design of liquid crystal display devices, a glass board used for a liquid crystal panel becomes large in size, and thus the board to be connected by TAB mounting is lengthened corresponding to the glass board. Therefore, there is a risk that the displacement as described above appears prominently.

The present invention has been implemented in view of the foregoing point, and an object thereof is to provide a board device and a board in which a positional displacement of each terminal group when a first board is subjected to thermocompression bonding is suppressed.

### SUMMARY OF THE INVENTION

According to the present invention, a board device includes a plurality of flexible first boards each of which has a first terminal group of a plurality of terminals arranged in juxtaposition with one another on a second board at a predetermined pitch under thermocompression, wherein a plurality of second terminal groups are arranged in juxtaposition with one another in a longitudinal direction on the second board corresponding to the terminal groups of the first boards, each of the second terminal groups includes a plurality of terminals each of which is electrically connected to each terminal of the first terminal groups of the first boards by thermocompression bonding, and the pitch between each terminal group located at the outermost end in the second terminal groups and the second terminal group adjacent to the terminal group concerned is set to be smaller than the predetermined pitch under a state before the first boards are bonded under thermocompression.

According to the present invention, a board to which a plurality of first boards each having a flexible first terminal group of a plurality of terminals arranged in juxtaposition with one another are bonded at a predetermined pitch under thermocompression, includes:

a board main body; and

a plurality of second terminal groups that are arranged in juxtaposition with one another in a longitudinal direction on the board main body corresponding to the first board terminal groups, wherein each second terminal group includes a plurality of terminals that are bonded to the respective terminals of the first terminal group of the first board under thermocompression and electrically connected to the terminals of the first terminal group, and the pitch between each terminal group located at the outermost end in the second terminal groups and the second terminal group adjacent to the terminal group concerned under a state before the first boards are bonded under thermocompression is set to be smaller than a predetermined pitch corresponding to an extension amount of the board main body when the first boards are subjected to thermocompression bonding.

Before the first boards are bonded to the second board under thermocompression, the pitch between the second terminal group located at the outermost end and the second terminal group adjacent to the second terminal group concerned is set to be smaller than the predetermined pitch under the state that the first boards are bonded to the second board under thermocompression, whereby the positional displacement of each terminal group due to the extension of the board when the first boards are bonded to the second board under thermocompression can be suppressed.

### BRIEF DESCRIPTION OF THE DRAWINGS

FIG. 1 is a plan view showing a liquid crystal display device having a board device according to a first embodiment of the present invention;

FIG. 2(a) is a diagram showing pre-connection pitches of some of second terminal groups of the board device of the first embodiment;

FIG. 2(b) is a diagram showing the other pre-connection pitches of second terminal groups of the board device,

FIG. 3 is an enlarged view showing a state before the connection of the board device;

FIG. 4 is an enlarged view showing the connection state of the board device;

FIG. 5(a) is a diagram showing some pitches of pre-connection second terminal groups of a board device according to a second embodiment of the present invention; and

FIG. 5(b) is a diagram showing the other pre-connection pitches of second groups of the board device.

### DETAILED DESCRIPTION OF THE PREFERRED EMBODIMENTS

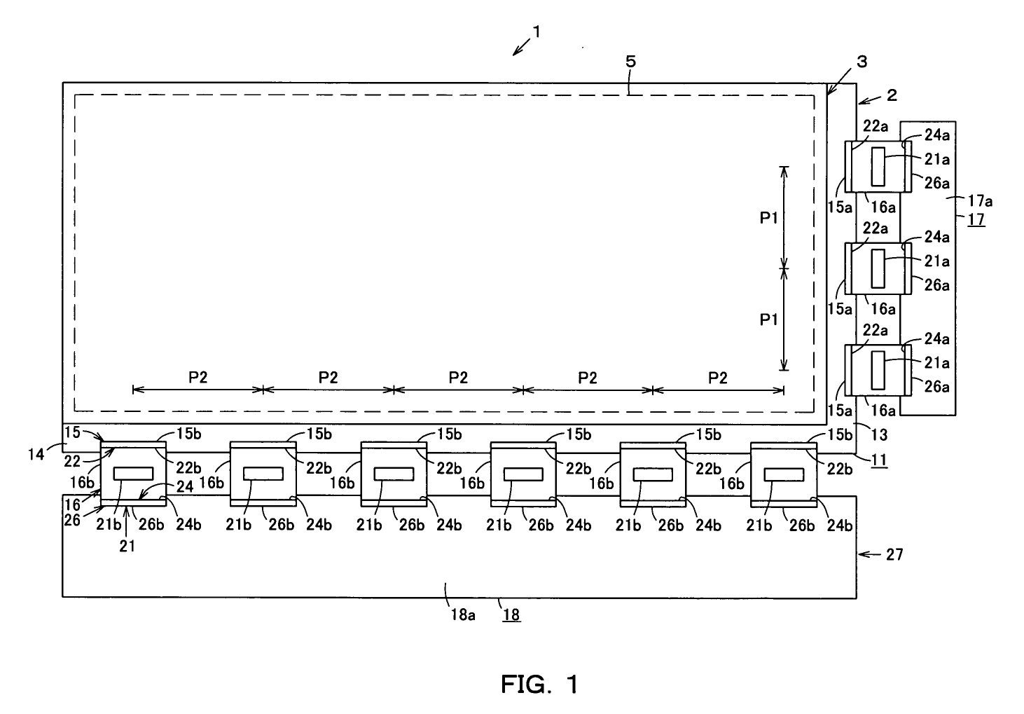

The construction of a first embodiment of the present invention will be described with reference to FIGS. 1 to 4.

FIG. 1 shows a part of a liquid crystal display device as a display device. In FIG. 1, 1 represents an active matrix type liquid crystal display element as a display element, that is, a liquid crystal panel. The liquid crystal panel 1 has an array board 2, an opposing board 3 and a liquid crystal layer (not shown) interposed between the array board 2 and the opposing board 3, and the boards 2 and 3 are adhesively attached to each other at the surrounding portion of the liquid crystal layer by sealing agent, thereby the liquid crystal layer is held. A rectangular effective display portion 5 as an image display area which can display an image is provided at the center portion of the liquid crystal panel 1. A plurality of pixels (not shown) are arranged in the effective display portion 5 in a matrix form along the longitudinal and lateral directions of the liquid crystal panel 1.

The array board 2 has a glass board 11 which is an insulating board as a translucent base material, and signal lines and scan lines (not shown) are arranged on one principal surface of the glass board 11 so as to be substantially orthogonal to one another. Furthermore, the pixels of the effective display portion 5 are located in the respective areas which are partitioned and surrounded by the scan lines and the signal lines. Furthermore, each of these pixels is provided with a thin film transistor (TFT) as a switching element, and a pixel electrode. Each pixel electrode is electrically connected to the thin film transistor in the same pixel, and controlled by the thin film transistor concerned.

Furthermore, the glass board 11 is projected from the effective display portion 5 of the liquid crystal panel 1, and the projecting portions serve as connecting portions 13, 14 as slender and rectangular frame portions. These connecting portions 13, 14 are provided with a plurality of glass side terminal groups 15a, 15b as lead terminal groups having glass side terminals as a plurality of lead terminals (not shown) drawn out from the right edge and the lower edge of the effective display portion 5 of the liquid crystal panel 1, and the glass side terminal groups 15a, 15b are arranged at predetermined pitches. A plurality of TCPs (Tape Carrier Package) 16a, 16b corresponding to flexible boards as first boards are subjected to thermocompression bonding and thus electrically and mechanically connected to the glass side terminal groups 15a, 15b via anisotropic conductive films (hereinafter referred to as ACF) (not shown) by TAB (Tape Automated Bonding) using a connecting device (not shown). Each TCP 16a is subjected to thermocompression bonding and thus electrically and mechanically connected to a gate board as a second board, that is, a gate PCB (Print Circuit Board) 17 via ACF, and each TCP 16b is subjected to thermocompression bonding and thus electrically and mechanically connected to the source board as the second board, that is, a source PCB 18 via ACF.

The respective glass side terminal groups are OLB (Outer Lead Bonding) terminals formed of electrically conductive members such as ITO, and arranged at a predetermined pitch at substantially equal intervals.

Furthermore, each TCP 16a is formed of a flexible material such as polyimide which has a larger thermal expansion coefficient than a material such as glass epoxy which forms the gate PCB 17, and designed in a rectangular shape. For example, a plurality of TCPs 16a described above are arranged along the short side of the array board 2 so as to be spaced from one another at a substantially equal interval.

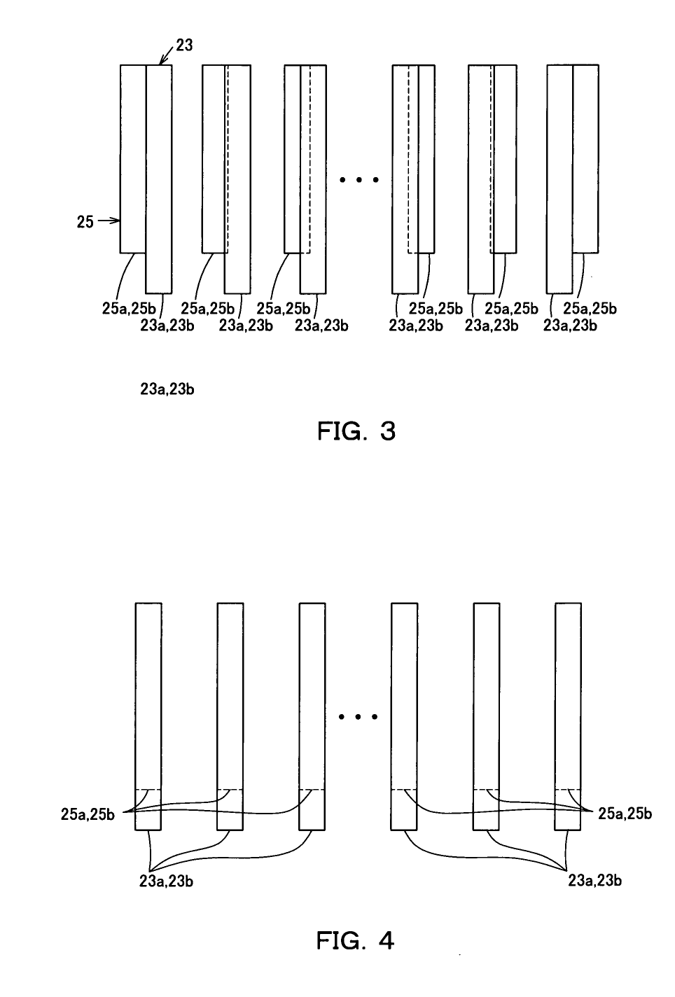

Each TCP 16a is provided with a gate driver 21a serving as a gate driving IC substantially at the center portion thereof, and also a plurality of first tape side terminals as flexible board side terminals (not shown) which are electrically and mechanically connected to glass side terminals constituting each glass side terminal group 15a are led out from each gate driver 21a to the array board 2 side to form each first tape side terminal group 22a. In addition, a plurality of flexible board side terminals corresponding to first terminals as terminals which are electrically and mechanically connected to the gate PCB 17 side, that is, a plurality of second tape side terminals 23a (FIGS. 3 and 4) are led out to the gate PCB 17 side at the opposite side to the first tape side terminals to form each second tape side terminal group 24a corresponding to a flexible board side terminal group as a first terminal group, thereby a so-called COF (Chip On FPC) tape is formed.

Likewise, each TCP 16b is formed of a flexible material such as polyimide which has a larger thermal expansion coefficient than a material such as glass epoxy which forms the source PCB 18, and designed in a rectangular shape. For example, a plurality of TCPs 16b described above are formed along the long side of the array board 2 so as to be spaced from one another at a substantially equal interval.

Each TCP 16b is provided with a source driver 21b serving as a source driving IC substantially at the center portion thereof, and a plurality of first tape side terminals as flexible board side terminals (not shown) which are electrically and mechanically connected to glass side terminals constituting each glass side terminal group 15b are led out to the array board 2 side to form each first tape side terminal group 22b. In addition, a plurality of flexible board side terminals corresponding to first terminals as terminals which are electrically and mechanically connected to the source PCB 18 side, that is, a plurality of second tape side terminals 23b (FIGS. 3 and 4) are led out to the source PCB 18 side at the opposite side to the first tape side terminals to form each second tape side terminal group 24b corresponding to a flexible board side terminal group as a first terminal group, thereby a so-called COF tape is formed.

Furthermore, the gate PCB 17 includes a board main body 17a formed in an elongated shape along the short side of the array board 2, and various kinds of circuits (not shown) for driving the gate drivers 21a are provided on the board main body 17a. In addition, a plurality of, for example, three board side terminal groups 26a as second terminal groups in which a plurality of board side terminals 25a as second terminals which are respectively electrically and mechanically connected to the second tape side terminals 23a of the second tape side terminal group 24a of each TCP 16a are arranged in juxtaposition with one another are formed at the left end portion of FIG. 1 opposing the array board 2 so as to be electrically connected to various kinds of circuits on the gate PCB 17, and arranged so as to be spaced from one another in the longitudinal direction of the gate PCB 17.

Furthermore, the source PCB 18 has a board main body 18a formed in an elongated shape along the long side of the array board 2, and various kinds of circuits (not shown) for driving the source drivers 21b are provided on the board main body 18a. In addition, a plurality of, for example, six board side terminal groups 26b as second terminal groups in which a plurality of board side terminals 25b as second terminals which are respectively electrically and mechanically connected to the second tape side terminals 23b of the second tape side terminal group 24b of each TCP 16b are arranged in juxtaposition with one another are formed at the upper end portion of FIG. 1 opposing the array board 2 so as to be electrically connected to various kinds of circuits on the source PCB 18, and arranged so as to be spaced from one another in the longitudinal direction of the source PCB 18.

TCPs 16a, 16b, PCBs 17, 18 and the board side terminal groups 26 constitute the board device 27.

All or any one of the glass side terminal groups 15a, 15b may be referred to as the glass side terminal group 15, all or any one of TCPs 16a, 16b may be referred to as TCPs 16, all or any one of the drivers 21a, 21b may be referred to as the driver 21, all or any one of the first tape side terminals 22a, 22b may be referred to as the first tape side terminal group 22, all or any one of the second tape side terminals 23a, 23b may be referred to as the second tape side terminal 23, all or any one of the second tape side terminal groups 24a, 24b may be referred to as the second tape side terminal group 24, all or any one of the board side terminals 25a, 25b may be referred to as the board side terminal 25, and all or any one of the board side terminal groups 26a, 26b may be referred to as the board side terminal group 26.

The first tape side terminals constituting the first tape side terminal group 22 are OLB terminals formed of an electrically conductive material such as copper. They serve as connection terminals for connection to the glass side terminals constituting the glass side terminal group 15, and are arranged at a substantially equal interval and connected to the glass side terminals by ACF connection. Here, the pitch of the first tape side terminals is subjected to so-called reducing correction corresponding to the thermal expansion of the material of TCP 16 so as to be narrower than that of the glass side terminals under the state before the connection and substantially equal to the pitch of the glass side terminals due to the thermal expansion of TCP 16 under the state after the connection.

Likewise, the second tape side terminals 23 constituting the second tape side terminal group 24 are OLB terminals formed of an electrically conductive material such as copper. They serve as connection terminals for connection with the board side terminals 25 constituting the board side terminal group 26, and are arranged at a substantially equal interval and connected to the board side terminals 25 by ACF connection. Here, the pitch of the second tape side terminals 23 is subjected to the reducing correction so as to be narrower than that of the board side terminals 25 under the state before the connection shown in FIG. 3, and substantially equal to the pitch of the board side terminals 25 due to the thermal expansion of TCP 16 under the state after the connection shown in FIG. 4.

Any setting such as the setting of gradually reducing the pitch between the terminals as the terminal position is away from the center side in the width direction of TCP 16 may be carried out as the above reducing correction.

Each of the tape side terminal groups 22, 24 has approximately 125 terminals, for example, and it has a total length of approximately 400 μm.

Furthermore, the respective board side terminals 25 are juxtaposed with one another at a predetermined pitch in the longitudinal direction of the PCB 17, 18 corresponding to the number of the second tape side terminals 23.

The board side terminal groups 26a, 26b are arranged at the substantially equal intervals of predetermined pitches P1, P2 under the state that TCPs 16a, 16b are subjected to ACF connection, and adjacent to one another at the predetermined pitches P1, P2 except for the board side terminal groups located at the outermost ends under the state before the connection of TCPs 16a, 16b, that is, the board side terminal groups located at the upper and lower ends of FIG. 1 with respect to the board side terminal groups 26a and the board side terminal groups located at the right and left ends of FIG. 1 with respect to the board side terminal groups 26b. The board side terminal groups located at the outermost ends are adjacent to one another at pitches smaller than the predetermined pitches P1, P2. That is, the arrangement of the board side terminal groups 26 themselves is subjected to the reducing correction in the longitudinal direction of the PCBs 17, 18 under the state before the connection.

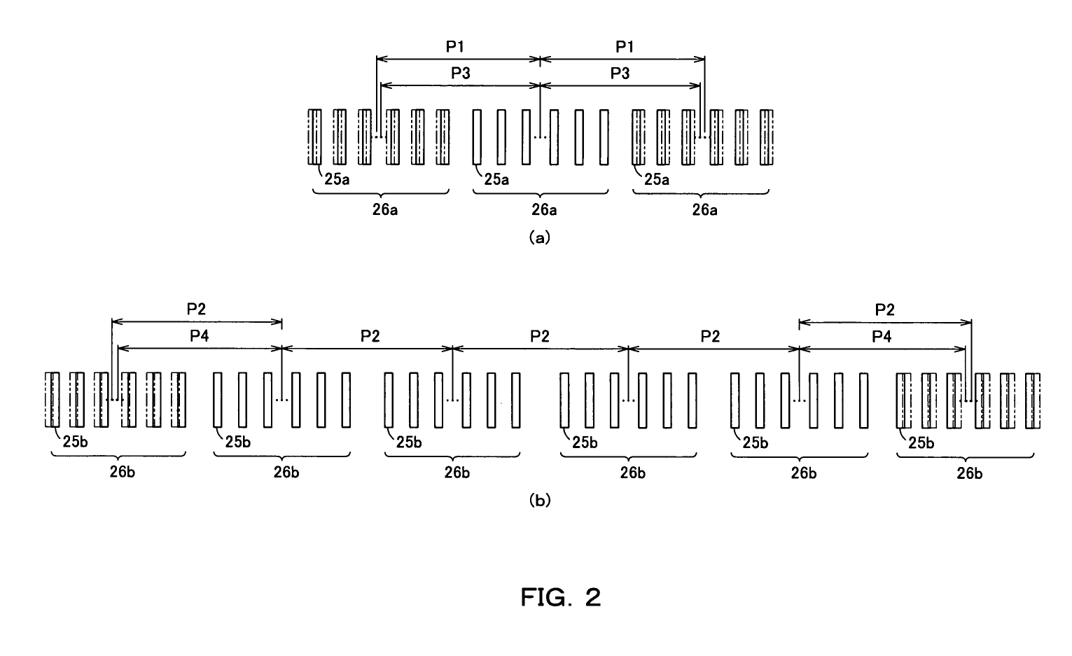

Specifically, in this embodiment, three TCPs 16a connected to the gate PCB 17 are provided, and thus the pitch of TCPs 16a is set to a pitch P3 achieved by subjecting the predetermined pitch P1 (an imaginary line of FIG. 2(a)) to the reducing correction as indicated by a solid line of FIG. 2(a). Furthermore, since six TCPs 16b connected to the source PCB 18 are provided, with respect to the pitch of TCPs 16b, the pitch of the other TCPs 16b than TCP 16b located at the outermost end is set to the predetermined pitch P2, and the pitch between TCP 16b located at the outermost end and the adjacent TCP 16b is set to a pitch P4 achieved by subjecting the predetermined pitch P2 (an imaginary line of FIG. 2(b)) to the reducing correction as indicated by a solid line of FIG. 2(b).

Here, the pitches P3, P4 are set to be small corresponding to the extension amount in the longitudinal direction of the board main bodies 17a, 18a of the PCBs 17, 18 under the thermocompression bonding due to the ACF connection of TCP 16. In this embodiment, they are arranged so as to be shifted to the center side in the longitudinal direction of the PCBs 17, 18 by approximately 20 μm to 30 μm.

Next, the operation of the first embodiment will be described.

The connecting device arranges TCPs 16 having the drivers 21 mounted thereon at the predetermined pitches P1, P2 via ACF (not shown) on the connecting portions 13, 14 of the liquid crystal panel 1 having the pixels, the thin film transistors, or the like formed thereon and on PCBs 17, 18 having various kinds of circuits formed thereon.

When TCPs 16 are bonded to the glass board 11 and PCBs 17, 18 under thermocompression by using a laser or the like under the above state, the first tape side terminal groups 22 and the second tape side terminal groups 24 of TCPs 16 and the board side terminal groups 26 of the PCBs 17, 18 are positionally displaced from one another due to the thermal expansion of TCPs 16 and the thermal expansion of the board main bodies 17a, 18a of the PCBs 17, 18, and the first tape side terminals are positionally overlapped with the glass side terminals and the second tape side terminals 23 are positionally overlapped with the board side terminals 25, so that they are electrically and mechanically connected to one another as shown in FIG. 4.

As described above, according to the first embodiment, the pitches P3, P4 between the board side terminal group 26 located at the outermost ends and the board side terminal group 26 adjacent to the board side terminal group 26 concerned under the state before TCPs 16 are subjected to thermocompression bonding are set to be smaller than the predetermined pitch P1, P2 under the state that TCPs 16 are subjected to thermocompression bonding, thereby suppressed is the positional displacement between each second tape side terminal group 24 and each board side terminal group 26 due to the extension of the board main bodies 17a, 18a of the PCBs 17, 18 when TCPs 16 is subjected to thermocompression bonding.

That is, in consideration of the fact that the first tape side terminal groups 22 are connected to the glass board 11 side of the array board 2 having relatively small extension, TCPs 16 are arranged at the substantially equal pitch. Therefore, the board side terminal groups 26 are subjected to reducing correction at PCB 17, 18 sides, whereby the positional displacement between each second tape side terminal group 24 and each board side terminal group 26 can be suppressed without displacement in the connection between the glass side terminal group 15 and the first tape side terminal group 22 of the array board 2.

In particular, corresponding to the large-size design of the liquid crystal panel 1, each PCB 17, 18 has been recently promoted to become longer in length. Therefore, the displacement based on the extension of the board main bodies 17a, 18a of the PCBs 17, 18 at the ACF connection time prominently appears in the board side terminal groups 26 at the outermost ends. Therefore, by subjecting the positions of the board side terminal groups 26 to reducing correction as described above, the positional displacement between the second tape side terminal group 24 and the board side terminal group 26 can be reliably suppressed.

Furthermore, by setting the pitches P3, P4 corresponding to the extension amounts of the board main bodies 17a, 18a of the PCBs 17, 18 when the TCP 16 is subjected to thermocompression bonding, the pitch of each board side terminal group 26 is made substantially equal to the predetermined pitches P1, P2, and thus the positional displacement between each second tape side terminal group 24 and each board side terminal group 26 can be suppressed even more reliably.

Furthermore, the positions of the board side terminal groups 26 are displaced as a whole in the longitudinal direction of the PCBs 17, 18 due to the extension of the board main bodies 17a, 18a of the PCBs 17, 18. However, the extension amounts of the board main bodies 17a, 18a of the PCBs 17, 18 are not so large. Therefore, with respect to the displacement between each board side terminal group 26 other than the terminal groups 26 located at the outermost ends and each second tape side terminal group 24, the board side terminals 25 and the second tape side terminals 23 fall into a connectable range, and thus by merely conducting the reducing correction only on the board side terminal groups 26 located at the outermost ends, the board side terminals 25 of each board side terminal group 26 and the second tape side terminals 23 of each second tape side terminal group 24 can be reliably connected to one another with no displacement.

In addition, in the liquid crystal panel 1 or the like, the pitch between the terminals is set to be narrow, and thus there is a risk that the terminals are short-circuited to each other because of the displacement of the connection between the terminals or desired circuits cannot be connected to each other. Therefore, the respective terminals can be reliably electrically and mechanically connected to one another by performing the reducing correction as described above, and thus the mounting yield and the mounting reliability can be enhanced.

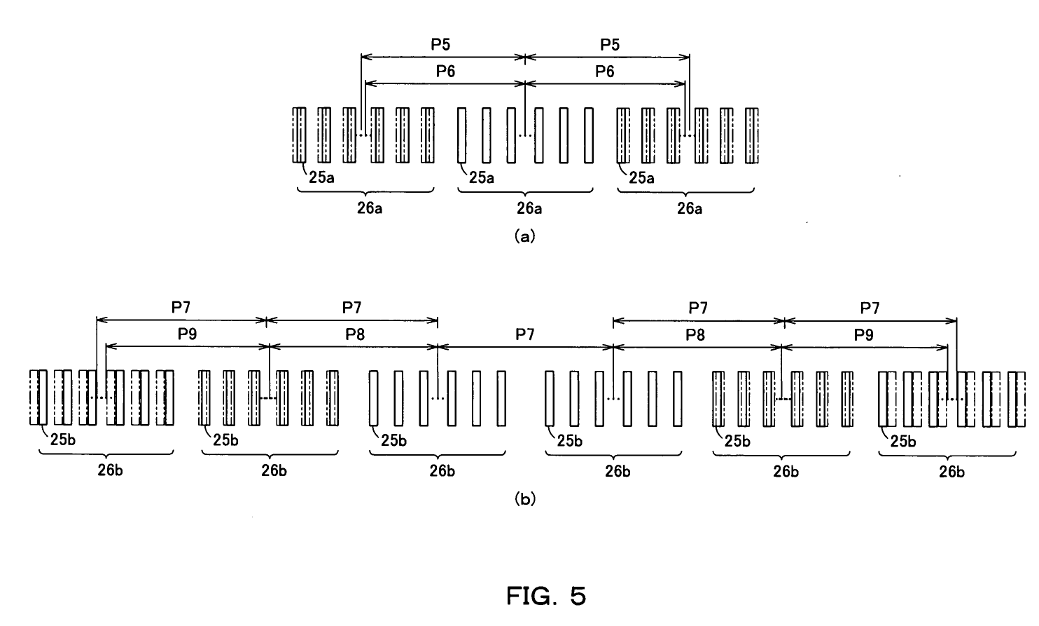

Next, a second embodiment will be described with reference to FIG. 5. The same constructions and operations of the first embodiment are represented by the same reference numerals, and the description thereof is omitted.

In the second embodiment, with respect to each board side terminal group 26, the pitch between the adjacent board side terminal groups 26 located at both the end sides of the PCBs 17, 18, that is, at the outside in the longitudinal direction is set to be smaller than the pitch between the adjacent board side terminal groups 26 at the center side of the PCBs 17, 18. In other words, according to the second embodiment, the pitch between the adjacent board side terminal groups 26 is set to be reduced corresponding to the extension amount of the board main bodies 17a, 18a of the PCBs 17, 18 as they are away from the center in the longitudinal direction of the PCBs 17, 18.

Specifically, as indicated by solid lines of FIG. 5(a), the pitch of the board side terminal groups 26a is set to a pitch P6 achieved by conducting the reducing correction on a predetermined P5 (imaginary line of FIG. 2(a)) when ACF connection of the TCP 16a is carried out.

Furthermore, with respect to the pitches of the board side terminal groups 26b, as indicated by solid lines of FIG. 5(b), the pitch between the board side terminal groups 26b at the extreme center side is set to a predetermined pitch P7 at the ACF connection time of the TCP 16a, the pitch between each board side terminal group 26b at the extreme center side and each board side terminal group 26b which is outwardly adjacent to the board side terminal group 26b concerned in the longitudinal direction of the PCB 18 is set to a pitch P8 which is set to be smaller than the predetermined pitch P7 corresponding to the extension amount of the board main body 18a of the PCB 18 at these positions, and the pitch between each of these board side terminal groups 26b and the board side terminal group 26 located at the outermost end is set to a pitch P9 which is smaller than the predetermined pitch P7 and the pitch P8 corresponding to the extension amount of the board main body 18a of the PCB 18 at these positions.

In this embodiment, for example, the pitch P8 is set to be smaller than the predetermined pitch P7 by 10 μm, and the pitch P9 is set to be smaller than the predetermined pitch P7 by 20 μm.

TCPs 16 on which the drivers 21 are mounted are respectively disposed at the predetermined pitches P5, P7 via the ACF (not shown) on the connecting potions 13, 14 of the liquid crystal panel 1 on which the pixels and the thin film transistors are formed, and on PCBs 17, 18 on which various kinds of circuits are formed, and TCPs 16 are bonded to the glass board 11 and PCBs 17, 18 under thermocompression by using a laser or the like. At this time, the first tape side terminal groups 22 and the second tape side terminal groups 24 of TCPs 16 and the board side terminal groups 26 of the PCBs 17, 18 are positionally displaced from one another due to the thermal expansion of TCPs 16 and the thermal expansion of the PCBs 17, 18, so that the first tape side terminals are positionally overlapped with the glass side terminals and the second tape side terminals 23 are positionally overlapped with the board side terminals 25, and thus they are electrically and mechanically connected to one another.

As described above, the same action and effect as the first embodiment can be achieved by setting the pitch between the board side terminal group 26 located at the outermost end and the adjacent board side terminal group 26 to be smaller than the predetermined pitches P5, P7 as in the case of the construction of the first embodiment, and also the reducing correction is carried out on all the board side terminal groups 26, whereby all the board side terminal groups 26 can be positionally matched with the second tape side terminal groups 24 when TCPs 16 are subjected to thermocompression bonding, whereby the positional displacement between each second tape side terminal group 24 and each board side terminal group 26 can be reliably suppressed.

In each of the above-described embodiments, the flexible board may be an FPC (Flexible Print Circuit), COF or the like in place of the TCP.

The board device 27 is used as wires for the liquid crystal panel 1, however, it may be used for connection of terminals having any narrow pitch.

What is claimed is:

1. A board device including a plurality of flexible first boards each of which has a first terminal group of a plurality of terminals arranged in juxtaposition with one another, and a second board to which the first boards are bonded at a predetermined pitch under thermocompression, wherein a plurality of second terminal groups are arranged in juxtaposition with one another in a longitudinal direction on the second board corresponding to the terminal groups of the first boards, each of the second terminal groups comprises a plurality of terminals each of which is electrically connected to each terminal of the first terminal groups of the first boards by thermocompression bonding, and the pitch between each terminal group located at the outermost end in the second terminal groups and the second terminal group adjacent to the terminal group concerned is set to be smaller than the predetermined pitch under a state before the first boards are bonded under thermocompression.

2. The board device according to claim 1, wherein under the state before the first boards are bondedunder thermocompression, the pitch between the terminal group located at the outermost end in the second terminal groups and the adjacent second terminal group is set to be smaller than the predetermined pitch corresponding to the extension amount of the second board when the first boards are bonded under thermocompression.

3. The board device according to claim 1, wherein the pitch between each of the second terminal groups and one of the second terminal groups which are adjacent to the former second terminal group at both end sides of the second board is set to be smaller than the pitch between the former second terminal group and the other second terminal group adjacent to the center side of the second board.

4. The board device according to claim 1, wherein the first boards are flexible boards.

5. The board device according to claim 1, wherein the second board is a gate board for driving gate drivers.

6. The board device according to claim 1, wherein the second board is a source board for driving source drivers.

7. The board device according to claim 1, wherein the first boards are connected between the connection portion of the array board and the second board.

8. A board to which a plurality of flexible first boards each having a first terminal group of a plurality of terminals arranged in juxtaposition with one another and are bonded at a predetermined pitch under thermocompression, comprising:
a board main body; and
a plurality of second terminal groups that are arranged in juxtaposition with one another in a longitudinal direction on the board main body corresponding to the first board terminal groups, wherein each second terminal group comprises a plurality of terminals that are bonded to the respective terminals of the first terminal group of the first board under thermocompression and electrically connected to the terminals of the first terminal group, and the pitch between each terminal group located at the outermost end in the second terminal groups and the second terminal group adjacent to the terminal group concerned under a state before the first boards are bonded under thermocompression is set to be smaller than a predetermined pitch corresponding to an extension amount of the board main body when the first boards are subjected to thermocompression bonding.

9. The board device according to claim 8, wherein the first boards are flexible boards.

10. The board device according to claim 8, wherein the board is a gate board for driving gate drivers.

11. The board device according to claim 8, wherein the board is a source board for driving source drivers.

12. The board according to claim 8, wherein the board is connected to a connection portion of an array board via the first boards.
